(19) United States
(12) Patent Application Publication
(10) Pub. No.: US 2012/0268044 A1
(43) Pub. Date: Oct. 25, 2012

(54) High Efficiency All-Electric Vehicle Propulsion System

(76) Inventor: Vladimir A. Shvartsman, Louisville, KY (US)

(21) Appl. No.: 13/091,590

(22) Filed: Apr. 21, 2011

(51) Int. Cl. H02P 23/00

(52) U.S. Cl. 318/139

(57) ABSTRACT

An all-electric vehicle propulsion system using a readily available high frequency AC Motor such as a 3-phase 400 Hz motor. A step-down gearbox increases torque and power thus decreasing the need for a high-power motor. Also, with the controllers of the invention, readily available, inexpensive batteries can be used as a primary source of energy. An efficient C&A-DC/DC step-up converter to power a high-efficiency motor driver can force the AC-motor windings circulate current in a resonance mode at around 220 volts. While 400 Hz and 220 volts are preferred, any voltage or frequency may be used, as well as any number of phases. Vehicle speed and torque can controlled by changing frequency and voltage applied to the motor usually using a variable resistor.

### BACKGROUND

1. Field of the Invention

The present invention relates generally to the field of electric vehicles and more particularly to a hi-efficiency, all-electric vehicle propulsion system using a 400 Hz (or other frequency) 3-phase AC motor that supplies kinetic energy to the wheels.

2. Description of the Prior Art

An electric vehicle (EV) uses one or more electric motors for propulsion. Electric vehicles can include electric cars, electric trains, electric boats, electric motorcycles and scooters, forklifts, golf carts, and the like. The idea of using an electric motor to power a vehicle was conceived a long time ago by Edison and improved upon by Tesla who later added the most significant improvements to move it closer to the reality. Electric vehicles first came into existence in the mid-19th century when electricity was among the preferred methods for motor vehicle propulsion providing a level of comfort and ease of operation that could not be achieved by the gasoline automobiles of that time. In time, combustion engines have became the dominant propulsion method for cars, but electric power has remained commonplace in other vehicle types such as trains and smaller vehicles of all types.

During the last few decades, increased concern over the environmental impact of petroleum-based transportation infrastructure, along with increasing cost of oil, has led to renewed interest in an electric car. Electric cars differ from gas-powered vehicles in that the energy (electricity) is stored on-board the vehicle using a battery or super-capacitor. Vehicles using engines working on the principle of combustion can usually only derive their energy from a single source, usually non-renewable fossil fuels. One major advantage of an electrical vehicles is a regenerative braking and suspension known in the art giving the vehicle the ability to recover energy lost during braking restoring it to the on-board an energy-storing device. An intermediate vehicle—the hybrid car is fueled by gasoline and electric motors for improving efficiency; an electric vehicle is powered exclusively by electricity.

One of the major drawbacks to electric vehicles has been limited range before recharging of the batteries becomes necessary, as well as fairly long charging times. That, however, is changing with new battery technologies such as super high-capacity batteries with short charging times and more efficient on-board systems. Another drawback has been high cost. It would be particularly advantageous to have an all-electric vehicle propulsion system that was both efficient and had reduced cost.

Traditionally, vehicles have been built with rather high-power engines. The reason for using a high-power engine is so that the vehicle has high torque and power during acceleration. There is only 6-8 HP per thousand pounds required for maintaining speed around 65 MPH while the typical combined power of a modern vehicle has 100 HP and more. There is no economical reason for using that amount of power in a utility vehicle such as an all-electric car. In that respect, A hybrid car displays the better efficiency because the electric motor may only be used during acceleration, and during the rest of a trip, a low-power combustion engine maintains road speed. It would be advantageous to have an all-electric vehicle propulsion system that had high starting power and torque with good efficiency at road speeds.

A modern electric car is rather expensive, with the electric motor battery contributing most of the cost. Most present-day electric vehicles use DC brushless motors. The DC brushless motor is a high efficiency motor that achieves its efficiency mostly from the use of a permanent magnet. The permanent magnet is made from rare earth materials, and thus rather expensive; this forces up the cost of a DC brushless motor. Also, the high-power consumption requires a costly high-capacity battery. It would be very advantageous to have an electric vehicle propulsion system that avoided expensive DC brushless motors.

### SUMMARY OF THE INVENTION

Therefore, an object of the present invention is to make an all-electric vehicle less expensive and more efficient by using a readily available high frequency AC Motor such as a 3-phase 400 Hz motor. A step-down gearbox increases torque and power thus decreasing the need for a high-power motor. Also, with proper controllers, readily available, inexpensive batteries can be used as a primary source of energy. An efficient C&A-DC/DC step-up converter to power a high-efficiency motor driver can force the AC-motor windings circulate current in a resonance mode at around 220 volts. While 400 Hz and 220 volts are preferred, any voltage or frequency may be used, as well as any number of phases.

### DESCRIPTION OF THE FIGURES

Attention is now drawn to several drawings that illustrate features of the present invention:

FIG. 1 is a block-diagram showing an embodiment of the invention.

FIG. 2 shows a winding of an AC-motor and simplified block-diagram of a motor driver that provides a power to the windings.

FIG. 3 is a block-diagram showing an embodiment of a high-efficiency DC to 3-phase 220VAC converter capable of driving a 3-phase motor in a resonance mode configured as a classical Y (star) configuration.

FIG. 4 is a block-diagram of the 3-phase pulse generator and frequency controller.

FIG. 5 is a time-diagram of pulse sequences produced by the 3-phase pulse generator and frequency controller of FIG. 4

FIG. 6 is a diagram of the virtual battery.

FIG. 7 is a block-diagram of an embodiment of a multiply by 5, variable charge-and-add DC/DC (C&A-DC/5×DC) converter for generating 220VDC from four batteries (12VDC×4=48VDC).

FIG. 8 is a simplified diagram of the charge-and-add step-up/down, regulated converter.

FIG. 9 is a diagram of a voltage doubler.

FIG. 10 is a diagram of a step-up converter based on the voltage doublers.

FIG. 11 is a schematic showing an embodiment of a multiply by 8, variable charge-and-add DC/DC (C&A-DC/8×DC) converter for generating 220VDC from three batteries (12VDC×3=36VDC).

### DESCRIPTION

In order to solve the foregoing obstacles an AC motor typically capable of rotating at a much higher RPM than a standard 50-60 Hz AC motor is used. A 50-60 Hz AC motor has a maximum RPM of around 3,600-rpm. A high frequency motor (in the present case in the range of 350 Hz to 450 Hz) has a maximum RPM of around 14,000-rpm. The reason for using a motor of higher frequency that 60 Hz is that an electrical asynchronous 3-phase motor of a similar size, producing a similar torque, can produce higher power output if the rotational speed of the motor is increased. For example, If the torque of the motor is kept constant, the power will increase proportionally with increasing frequency. If the frequency is quadrupled, and if the torque is constant, the power output is generally quadrupled. This translates to a smaller size and weight of motor to achieve the same power.

A reduction-ratio gearbox can be used to provide lower RPM and higher torque. This allows the electrical motor to be downsized in terms of power output and torque. Using a gear with a 4:1 reduction increases torque four times over the torque created by the electric motor. Employing a gearbox helps to achieve several objectives; it helps vehicle acceleration and increases overall efficiency.

Another feature of the present invention is the use of a regulated high-efficiency charge-and-add DC/DC (C&A-DC/DC) converter for increasing a low voltage from batteries to a high voltage required for driving an AC-motor. The converter consumes very little power in its stand-by state, and delivers an output power at 99.99% to a low to medium load and about 94% to a full load. The converter delivers a regulated output voltage capable of increasing an input voltage of up to five times. Presently, lithium-based batteries are extremely expensive. Until new, high-power, high-voltage batteries become available, the present invention prefers using several low-cost 12 volt lead-acid batteries with the converter for powering the 220V AC motor. Of course, twenty batteries could be connected in a series to deliver the required voltage, but their total weight would prohibit such configuration. In the preferred embodiment, four batteries are used with the converter for generating 220V DC. The use of a high voltage motor results in smaller diameter power cables made of expensive and heavy copper; this helps decrease the overall weight and cost of the propulsion system.

Another feature of the present invention is a virtual battery (V-battery) made of a number of metal-film, high current, high-speed capacitors. The V-battery reduces loss of power on connective cables, decreases electromagnetic interference and stores energy required to meet surges of power required by sudden accelerations.

Another feature of the present invention is a variable-frequency (VF) motor driver. A VF-driver is a common industrial device. They made for a various power uses and are readily available from many vendors. In general applications, they do well, but their efficiency is not good enough for an all-electrical vehicle. A highly efficient motor driver has been designed to drive an AC-motor in Y-termination employing charging and discharging capacitors onto a motor's windings, thus creating a series resonance.

Another feature of the present invention is a three-phase voltage generator with an output pulse-width equal to a ¼ of the period. This can control the motor driver in such manner that it charges the winding capacitors for a precise time duration for the highest possible efficiency.

Another feature of the present invention is a potentiometer with its shaft mechanically connected to a gas pedal for controlling the VF-driver output frequency and the voltage output of the DC/DC converter.

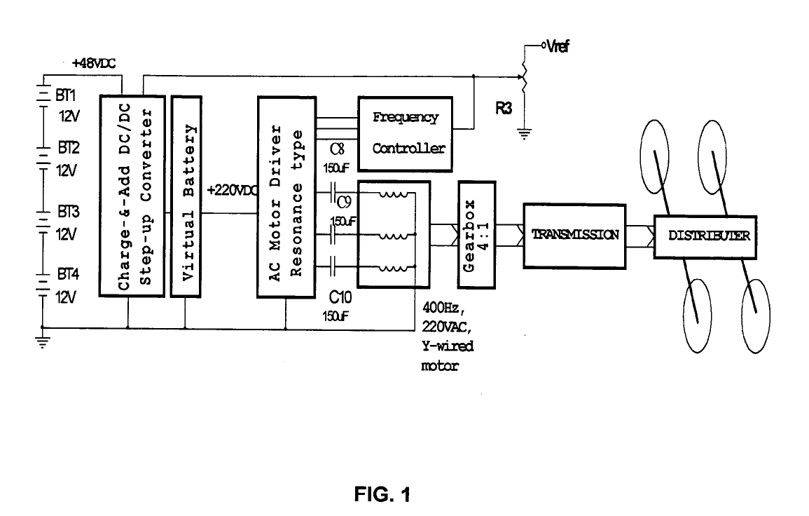

Turning to FIG. 1, an embodiment of an all-electric vehicle can be seen. A car transmission is mechanically connected to a high reduction-ratio gearbox. The gearbox has 4:1 reduction ratio. That means when the motor is rotated at 12,000 RPM, the gearbox delivers 3,000 RPM to the wheels that connect to the transmission to drive. This RPM is comfortable at speed of between 55 MPH to 65 MPH.

FIG. 1 shows a standard in industry an asynchronous 3-phase 220VAC Motor designed to work at 400 Hz. Reliable 400 Hz motors are known in the art and found in use in the aircraft industry, on navy ships, empowering drilling equipment, wall saws, and many other applications where a small size/weight motor is must. A four-pole motor driven by a 400 Hz current will rotate at a nominal speed of 12,000 RPM. With an increase of frequency, the motor rotates at a higher RPM. At 1,000 Hz, the motor will rotate at a nominal speed of 30,000 RPM. Increasing the speed is a simple way of getting a more powerful motor with a low weight, but making a bearing survive at such high speeds is not easy. Very high RPM will shrink life span of the bearings significantly and increase it costs substantially. Thus, the preferred applied frequency is designed to vary between 380 Hz to 420 Hz that makes after gearbox the rotation vary approximately from 2,000 RPM to 3,400 RPM. As it shown on FIG. 1, a reference voltage from a potentiometer (R1) that is mechanically connected to the “gas” pedal is applied simultaneously onto the frequency control of the motor driver and onto the C&A-DC/DC converter. Once an increased control signal reaches the frequency control, a higher frequency will be generated and applied into windings of the motor. The control signal applied into the C&A-DC/DC converter causes it to produce a higher voltage than 220VDC output voltage. The double control insures that the motor will be able to turn faster and have enough power for increasing the vehicle speed.

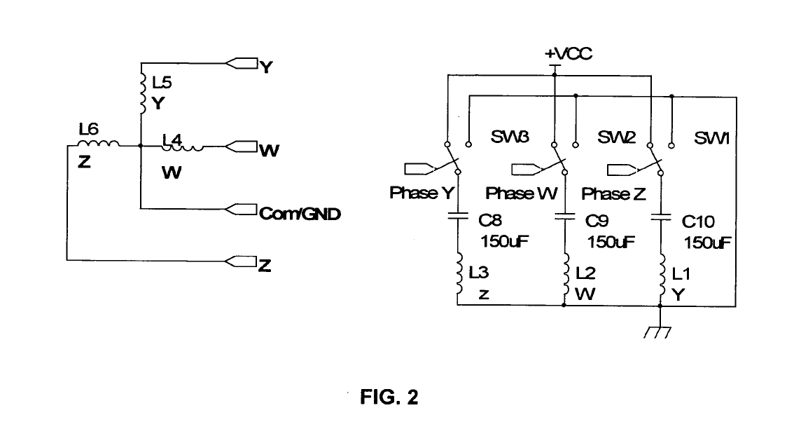

FIG. 2 shows windings of an AC motor connected as a classical Y-configuration. It is also shows a simplified functional diagram of the three-phase motor driver with capacitors and windings connected in series as a load of the push-pull driver.

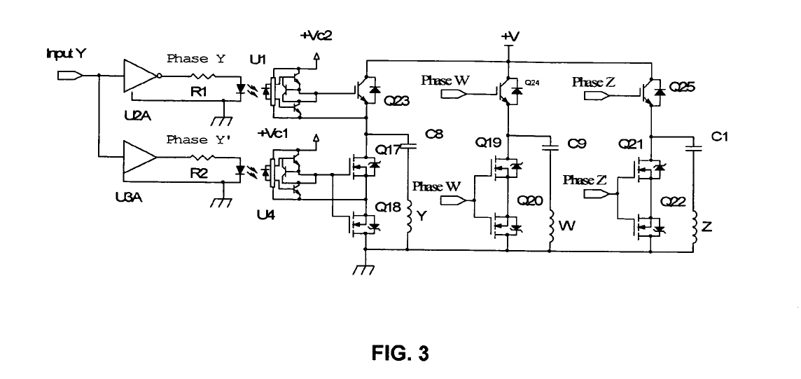

FIG. 3 shows a simplified schematic of a three-phase motor driver. It is one of many possible implementations of the functional diagram presented in FIG. 2. The motor driver is capable of delivering a wide range of frequencies to the three-phase AC motor. Power is transferred to windings of the motor in two cycles. During the first phase or during ¼ of the period, the IGBT will stay open, and a voltage from a power source will be applied to the capacitor connected in series with a motor winding. The capacitor will be charged to the maximum voltage. At the beginning of the cycle, a maximum charging current will rush through the winding. At the end of the cycle, the voltage on the capacitor will have reached the maximum, and current will stop flowing; This starts the second part of the cycle. The second phase is equal to a ¾ of the period. During that time, the IGBT will stay closed, and the pair of MOSFETs will stay open allowing the energy accumulated in the capacitor to be discharged onto the same winding. At the end of cycle, at the completion of a sine wave at the winding, the next consecutive cycle begins. The voltage applied to the winding is 220V AC or around 440V peak-to-peak. Two other windings will receive the power shifted in time phase in a timely fashion that simulates a full cycle of 400 Hz. Each of three capacitors should be selected to be of such capacitance that the power circulates in the L-C circuits near or at the natural resonance formed with the motor winding. The correct value of capacitors is rather difficult to calculate and depends on the motor. Tests with a various capacitors help to select a correct value. It was found a 430 UF capacitor works well for a 7.5 HP, 60 Hz motor and that a capacitor of about 150 UF works for a 400 Hz motor of the same power. The value of capacitor will increase with the increasing power of the motor. Observing a rather clean sine wave on an oscilloscope is the best test for determining whether the capacitor value is correct or not. All capacitors should preferably be metal-film, high current, and be at least rated at 600V for 220VAC voltage levels. For safety concerns, 1,200V capacitors are recommended. A particular capacitance value and rated voltage will depend on a particular motor and applied voltage.

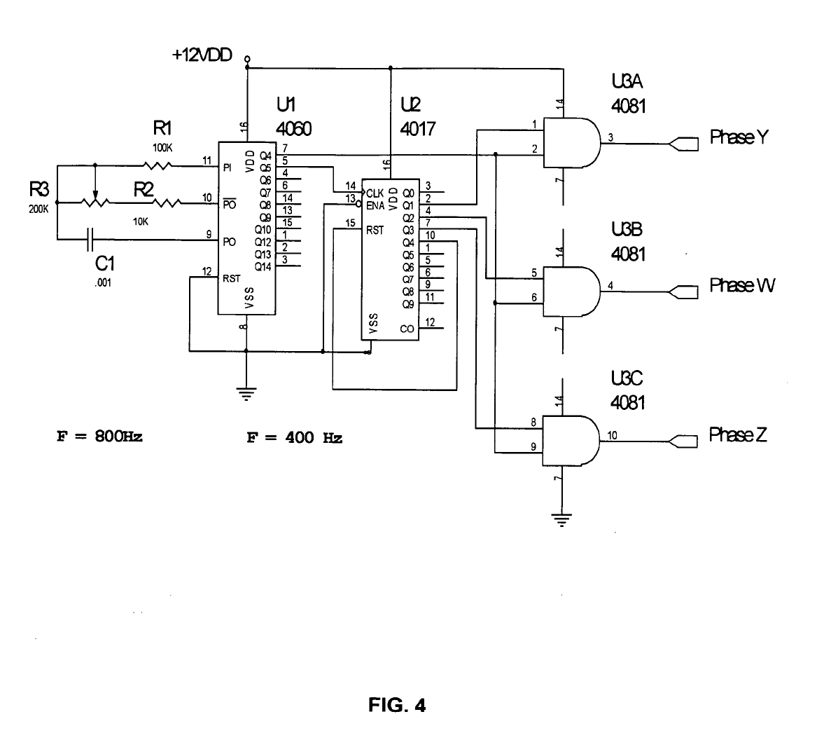

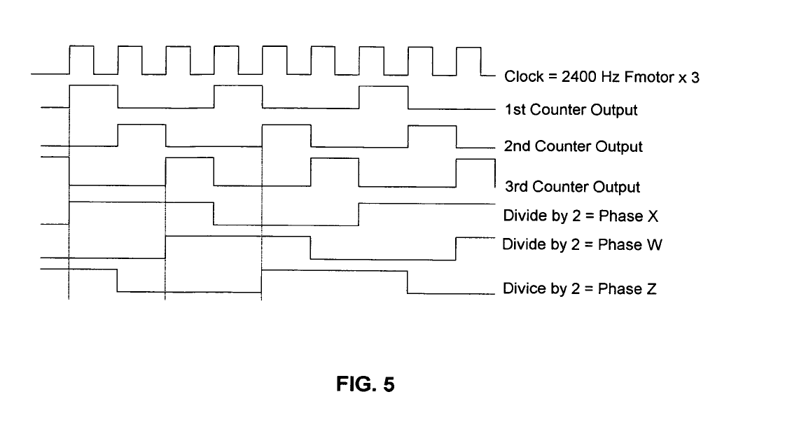

The motor driver is controlled by shifted-in-time pulses generated by the frequency control unit. FIG. 4 shows a simplified diagram of a three-phase pulse generator, and FIG. 5 represents a typical timing diagram. In this particular embodiment, the frequency control consists of a CD4060 (a ripple-carry binary counter/divider with a built in oscillator; a CD4017 (5-stage Johnson counter), and a CD4081 (quadruple 2-input AND gate). The frequency of the internal oscillator is set so that 800 Hz is generated on pin #7 (a waveform shown on FIG. 5, the top line), by two resistors (R1 and R2), a potentiometer (R3), and a capacitor (C1). Pin #7 of the CD4060 is connected to the inputs of the three AND gates, CD4081 (pins #2, 6, and 9). Pin #5 generates a square-wave signal (shown on FIG. 5, the second line down from the top) connected to the clock input (pin #14) of the CD4017. The CD4017 is configured as a divided by three, sequential controller. Its pins, #2, #4, and #7 are connected respectfully to pins #1, #5, and #8 of the corresponding AND gates of the CD4081. The result is combined clock pulses and a divided by two pulse. The AND gates generates three shifted in time pulses, equal to ¼ of the period. FIG. 5 shows all three pulses on three lowest lines. The each pulse applied on one of the corresponding motor drivers.

As it shown in FIG. 1, a reference voltage from the “gas” pedal which is connected mechanically to a potentiometer (R1) is applied simultaneously onto the frequency control of the motor driver and the C&A-DC/DC converter. Once a higher control signal is indicated, a control frequency higher than 400 Hz will be generated and applied into windings of the motor. The control signal applied into the C&A-DC/DC converter causes it to produce a higher than 220 VDC output voltage. The double control insures the motor will be able to turn faster, and have enough power for increasing the vehicle speed.

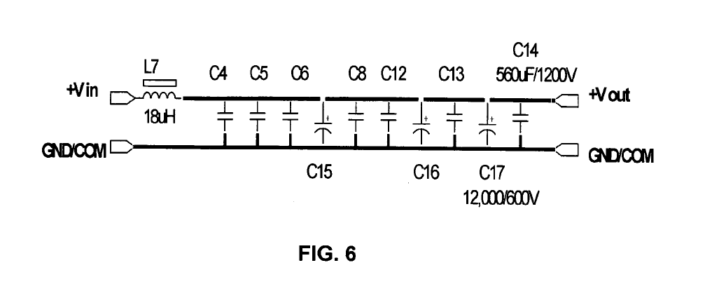

FIG. 6 shows a simplified diagram of a virtual battery (V-battery). It consists of seven metal-film, high current capacitors and three polar capacitors also designed to work at high-speed charging/discharging cycles and high current. While this number of components has been used for the preferred embodiment, any number of capacitors is within the scope of the present invention. All the capacitors have an extremely low leakage current that allows keeping accumulated energy for days. The output of the DC/DC converter (+V in terminal) charges the V-battery via a high-current choke of 18 mH made of several windings assembled on a gapped toroid (for preventing its saturation). The choke prevents spikes and overshoots. A DC voltage (about 220 V) is available at the terminal +V out. High-speed, high current capacitors are essential for minimizing loss, since the DC/DC converter converts energy at 12 KHz and higher with a typical switching frequency of from 12 kHz to at least 21 kHz or higher. Charging pulsing currents are typically high equaling up to five times of the output current, and reaching 250 A when the output current is 50 A.

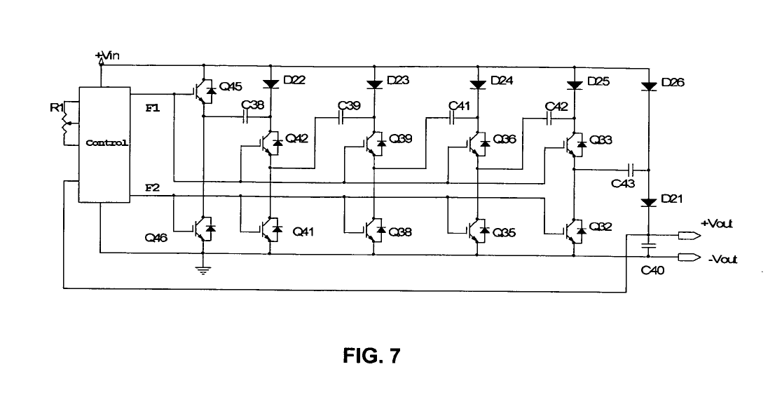

FIG. 7 is a functional diagram of the charge-and-add step-up converter (the cycle of adding together charges from all floating capacitors and generating a +V out). As is shown in FIG. 7, the floating capacitors (C49, C50, C54, C53, and C52) are charged when switches SW26, SW27, SW28, SW29, and SW30 are conducting via diodes D33, D34, D35, D38, and D37. The +V out will be created as a result of the input voltage (V in) added to voltages on capacitors C51 when SW11, SW12, SW15, SW23, and SW25 are conducting. The output voltage is equal to: +V out=[+V in×(N+1)]−VL (voltage lost on diodes and switches). Where, “N” is a number of floating capacitors.

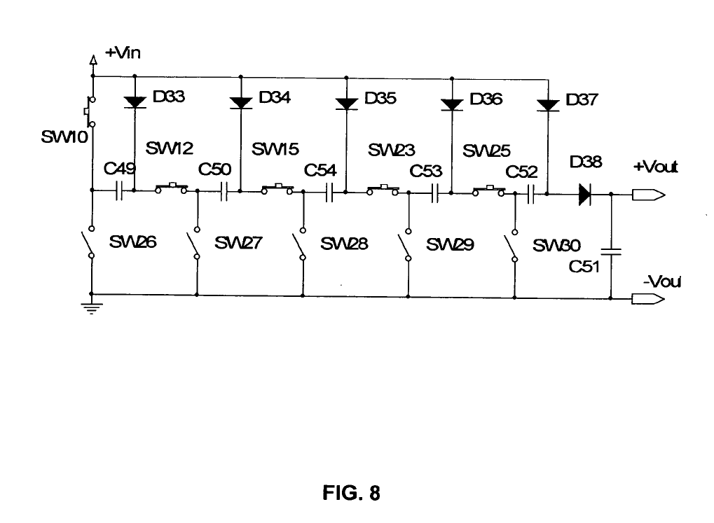

FIG. 8 is a simplified schematic showing an embodiment of a multiply by 5, variable charge-and-add DC/DC (C&A-DC/5×DC) converter for generating 220VDC from four batteries (12VDC×4=48VDC).

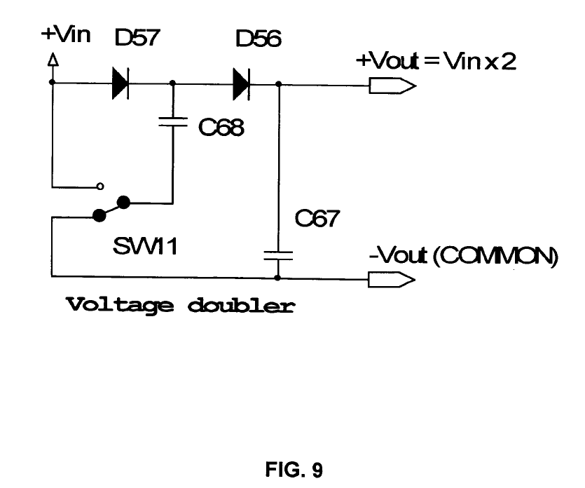

FIG. 9 shows a basic building block of the charge-and-add step up converter that doubles the input +Vin voltage. The converging occurs in two cycles. During the first charging cycle, the floating capacitor C68 is charged to Vin via diode (D52) and the 1-2 terminals of the switch (SW11). The second cycle starts from the moment the switch (SW11) changes states. Terminals 1-2 are disconnected, and terminals 2-3 connected. During that moment, the charge stored in capacitor C52 will be added to the input voltage, and the sum (Vin+Vc52) will be applied onto the capacitor C67 via the diode D51. By repeating these operations (toggling the switch rather frequently), the output voltage (+V out) will be close to double the input voltage. The preferred switching rate is around 12 kHz to over 21 kHz or higher. However, the higher the required output, the higher the frequency must be since when more energy is required, the number of pulses per unit time must be increased. The exact frequency used is thus a variable based on the type of motor, the applied load, and the motor's electrical frequency.

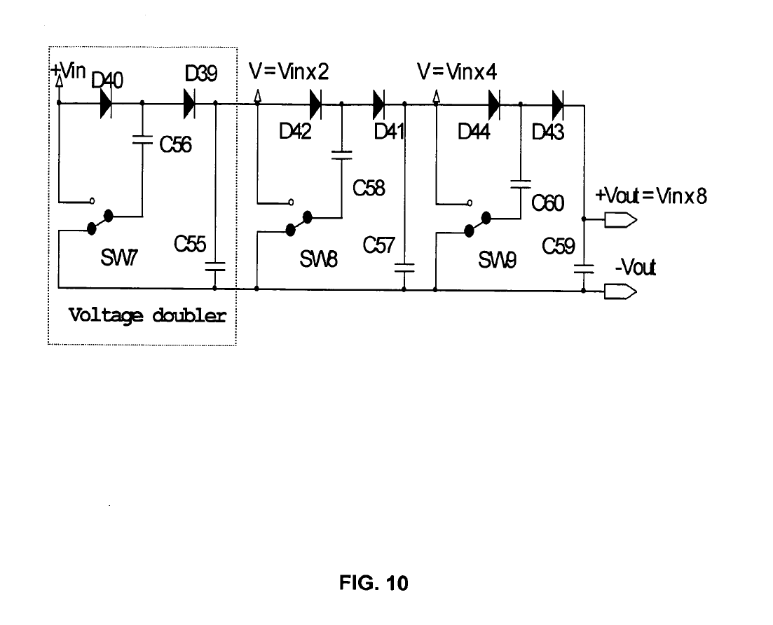

The FIG. 10 shows a simplified diagram of a step-up converter based on the voltage doubler, shown on FIG. 9.

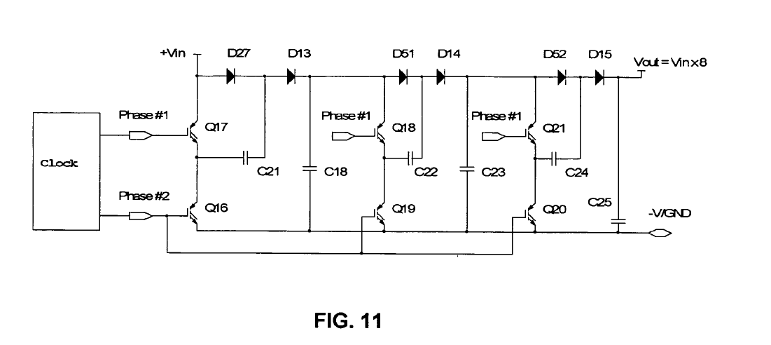

FIG. 11 is a simplified schematic an embodiment of a multiply by 8, variable charge-and-add DC/DC (C&A-DC/8×DC) converter for generating 220 VDC from three standard storage batteries (12VDC×3=36VDC). A converter based on the voltage doubler uses a twice as few switches to achieve the same voltage multiplication.

Changes and variations to the invention that would be understood by a person of skill in the art are within the scope of the invention.

I claim:

1. An all-electric vehicle propulsion system comprising:
a 400 Hz, 3-phase AC electric motor having three windings 120 electrical degrees out of phase;
a high reduction ratio gearbox mechanically connecting said AC electric motor to a vehicle's wheels;
a motor drive circuit delivering 400 Hz, 3-phase electrical current to said AC motor from a DC power supply;
a 3-phase pulse generator electrically connected to said motor drive circuit delivering pulses shifted by 120 electrical degrees each said pulse having a duration of ¼ cycle;
wherein each of said three windings of said AC electric motor has an associated capacitor, said capacitor being charged for ¼ cycle and then discharged through said winding in a manner that doubles voltage across said winding.

2. The all-electric vehicle propulsion system of claim 1 further comprising a virtual battery made from a plurality of low leakage capacitors, said virtual battery capable of holding charge for an extended time period, said virtual battery receiving charging current from a plurality of 12 volt storage batteries.

3. The all-electric vehicle propulsion system of claim 1 further comprising a charge-and-add DC/DC converter that converts low voltage from a plurality of storage batteries to at least 220 volts DC for driving said AC electric motor.

4. The all-electric vehicle propulsion system of claim 1 further comprising a variable resistor adapted to be mechanically coupled to an accelerator pedal on said vehicle, said variable resistor controlling frequency and voltage applied to said AC electric motor.

5. The all-electric vehicle propulsion system of claim 2 wherein there are four storage batteries connected in series.

6. The all-electric vehicle propulsion system of claim 2 wherein said low-leakage capacitors are metal film capacitors.

7. The all-electric vehicle propulsion system of claim 1 wherein aid DC/DC converter is adjustable step up/step down.

8. The all-electric vehicle propulsion system of claim 1 wherein said DC/DC converter converts 36-48 volts DC to at least 220 volts DC.

9. The all-electric vehicle propulsion system of claim 1 wherein said motor drive circuit includes a plurality of solid state relays.

10. An all-electric vehicle propulsion system comprising:
a 400 Hz, 3-phase AC electric motor having three windings 120 electrical degrees out of phase;
a high reduction ratio gearbox mechanically connecting said AC electric motor to a vehicle's wheels;
a motor drive circuit delivering 400 Hz, 3-phase electrical current to said AC motor from a DC power supply;
a 3-phase pulse generator electrically connected to said motor drive circuit delivering pulses shifted by 120 electrical degrees, each said pulse having a duration of ¼ cycle;
wherein each of said three windings has an associated capacitor, said capacitor being charged for ¼ cycle and then discharged through said winding in a manner that doubles voltage across said winding;
a charge-and-add DC/DC converter that converts low voltage from a plurality of vehicle batteries to at least 220 volts DC, said at least 220 volts being used to charge a virtual battery containing a plurality of low-leakage capacitors;
a variable resistor adapted to be mechanically coupled to an accelerator pedal on said vehicle, said variable resistor controlling frequency of said 3-phase pulse generator and output voltage of said DC/DC converter.

11. The all-electric vehicle propulsion system of claim 10 wherein said low-leakage capacitors are film capacitors.

12. The all-electric vehicle propulsion system of claim 10 wherein aid DC/DC converter is adjustable step up/step down.

13. The all-electric vehicle propulsion system of claim 10 wherein said DC/DC converter converts 36-48 volts DC to 220 volts DC.

14. The all-electric vehicle propulsion system of claim 10 wherein said motor drive circuit includes a plurality of solid state relays.

15. An electric vehicle propulsion system comprising, in combination:
a three-phase electric motor;
a capacitor on each phase winding of said electric motor that discharges into said phase winding;
a DC-AC converter and driver electrically connected to said electric motor that converts DC current from at least one battery into 3-phase AC current configured so that each of said capacitors charges for approximately ¼ cycle of said AC current;
wherein, said capacitors discharge through said windings in a manner that doubles AC voltage across said winding.

16. The electric vehicle propulsion system of claim 15 wherein said AC current has a frequency of 400 Hz.

17. The electric vehicle propulsion system of claim 15 wherein said DC-AC converter supplies approximately 220 volts AC.

18. The electric vehicle propulsion system of claim 15 further comprising a virtual battery as part of said DC-AC converter.

19. The electric vehicle propulsion system of claim 15 further comprising a variable resistor adapted to act as a vehicle accelerator controlling both frequency and voltage of said DC-AC converter.
